(19) United States
(12) Patent Application Publication
(10) Pub. No.: US 2026/0100317 A1
(43) Pub. Date: Apr. 9, 2026

(54) WALL-MOUNTABLE KEYPAD CONTROLLER AND LIGHT PIPE THEREFOR

(71) Applicants: SOMFY SYSTEMS INC., DAYTON, NJ (US); Somfy Activités SA, CLUSES (FR)

(72) Inventors: Tyler REICH, Dayton, NJ (US); Maxime LAPOUILLE, CLUSES (FR); Thomas RYCKEMBUSCH, CLUSES (FR)

(73) Assignees: SOMFY SYSTEMS INC., DAYTON, NJ (US); Somfy Activités SA, CLUSES (FR)

(21) Appl. No.: 18/905,247

(22) Filed: Oct. 3, 2024

(51) Int. Cl. H01H 9/16; F21V 8/00; G06F 3/02

(52) U.S. Cl. CPC H01H 9/161; G02B 6/0096; G06F 3/0202

(57) ABSTRACT

A keypad controller includes a housing portion, which houses therein: a printed circuit board assembly (PCBA) including a plurality of light sources arranged in a single line thereon; a carrier plate arranged adjacent the PCBA, the carrier plate comprising a through opening, aligned with the light sources; a light pipe arranged adjacent the through opening; a plurality of control buttons arranged on the carrier plate on either side of the light pipe. The keypad controller also includes a faceplate having an opening corresponding to the arrangement of the control buttons and light pipe on the carrier plate, permitting access thereto, the faceplate securable to the housing portion. A light pipe, for use in an electronic control device, includes a longitudinal extension and includes a rear face and a front face opposite thereto.

### FIELD OF INVENTION

The present invention relates to the field of controllers for home automation systems.

### BACKGROUND

Home automation systems are increasingly becoming commonplace. Such systems are used by homeowners to integrate and control multiple electrical and/or electronic devices in their homes. Homeowners are able to connect appliances, lights, automatic blinds or shutters, thermostats, security systems, telecommunication systems, etc., via a wireless network. These devices can be controlled using a controller, for example, a remote-control device such as a wall-mounted keypad. The wall-mounted keypad may be configured to provide feedback, for example, by illuminating one or more visual indicators thereby indicating a present state of the system, the control device, and/or simply as a guide to find the keypad in low light situations. U.S. Patent No. 5,191,265 describes a luminous feedback device.

Wall mounted keypads are sometimes configured to control more than one device or light source; therefore, the illuminated visual indicators provide indication as to which button or knob is intended to be controlling a particular device or light source. Often, the buttons or knobs are translucent and are illuminated by a light source embedded therein. Such arrangements are often aesthetically unappealing and can interfere with the ambiance of a room given its bright illumination. Moreover, if two buttons or knobs are arranged in close proximity to one another, there can be bleed over of the light from one button to the other.

Light pipes are used as light guides to channel light from a light source, often a light emitting diode (LED), housed in the wall-mounted keypad, towards control buttons to provide illumination. However, such light pipes often have light bleed between the areas to be defined or have hot spots, i.e., areas of concentrated brightness. Moreover, light pipes need to be sufficiently translucent to permit sufficient light transmission, which often reveals the LED and the printed control board assembly (PCBA) behind it.

It is an object of the present disclosure to provide a wall-mounted keypad that provides illuminated indication of its controls with sharply defined boundaries, no hot spots and sufficiently translucent for proper light transmission but sufficiently opaque to conceal the LED and PCBA. It is a further object of the present disclosure to provide a versatile light guide that is aesthetically appealing and that can be integrated into a wall mounted keypad, which can be used in different configurations regardless of the number of buttons.

The present invention provides solutions that overcome these drawbacks by providing a keypad controller having a light pipe that is aesthetically pleasing yet functional with sharply defined boundaries, no hot spots, and translucent enough for proper LED emission yet opaque enough to conceal the LED and PCBA behind it.

### SUMMARY

The present disclosure is directed to a keypad controller comprising: a housing portion, which houses therein: a printed circuit board assembly (PCBA) comprising a plurality of light sources arranged in a single line thereon; a carrier plate arranged adjacent the PCBA, the carrier plate comprising a through opening, aligned with the light sources; a light pipe arranged adjacent the through opening; a plurality of control buttons arranged on the carrier plate on either side of the light pipe; and a faceplate comprising an opening corresponding to the arrangement of the control buttons and light pipe on the carrier plate, permitting access thereto, the faceplate securable to the housing portion.

The present disclosure is also directed to a light pipe for use in an electronic control device, the light pipe having a longitudinal extension and comprises a rear face and a front face opposite thereto.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments that are presently preferred. It is understood, however, that the invention is not limited to the precise arrangements and instrumentalities shown. In the drawings:

FIG. 1A is a two-channel keypad according to the present invention;

FIG. 1B is a four-channel keypad controller according to the present invention;

FIG. 2 is an exploded view of the two-channel keypad of FIG. 1A;

FIG. 3 is a left-side view of a light pipe according to the invention

FIG. 4 is a top view of the light pipe depicted in FIG. 3;

FIG. 4A is a section view taken along line A-A as shown in FIG. 4;

FIG. 4B is a section view taken along line B-B as shown in FIG. 4;

FIG. 5 is a bottom perspective view of the light pipe as shown in FIG. 3;

FIG. 6 is a bottom view of the light pipe as depicted in FIG. 5;

FIGS. 7 A is schematic representation of the light pipe in use in a two-channel keypad; and

FIG. 7B is schematic representation of the light pipe in use in a four-channel keypad.

### DETAILED DESCRIPTION OF THE PREFERRED EMBODIMENTS

The headings used herein are for organizational purposes only and are not meant to be used to limit the scope of the description or the claims. As used throughout this application, the words "may" and "can" are used in a permissive sense (i.e., meaning having the potential to), rather than the mandatory sense (i.e., meaning must). Similarly, the words "include," "including," and "includes" mean including but not limited to. To facilitate understanding, like reference numerals have been used, where possible, to designate like elements common to the figures.

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

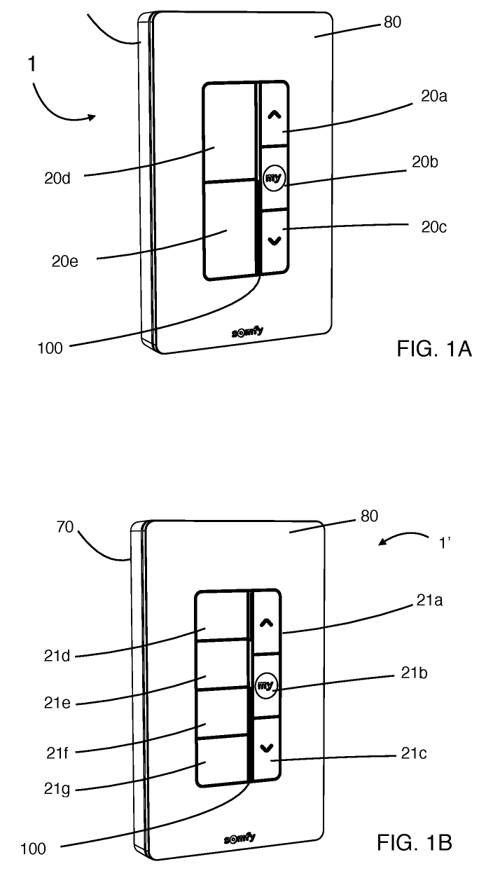

FIG. 1A shows a two-channel keypad controller 1, which includes a wall plate 70 and a face plate 80, which serve as a housing for the components described below. The keypad 1, further includes control buttons 20a – 20c, which are used to control functions of electrical and/or electronic devices, for example power on/off 20b or increasing or decreasing 20a, 20c. Further, control button 20b can be utilized such as to stop a function, for example, if used with a shade, and the shade is raising or lowering, a press of the control button 20b will stop the movement of the shade. Control button 20b can also be preprogrammed to move the shade to a preferred or favorite position, for example, by pressing the button twice. Similar features are also possible when the keypad controller is used to control lighting, audio, etc.

Control buttons 20d, 20e are used to switch control of different devices, e.g., a motorized shade, a motorized blind, motorized curtains, a motorized awning, motorized screens, motorized slats, a lighting source, an audio source, a fan, a security system etc. Alternatively, the control buttons 20d, 20e can be used to control the same type of devices located in different locations. In the example shown in FIG. 1A, control button 20d is actuated as indicated by the illuminated portion of light pipe 100 adjacent button 20d. Therefore, control buttons 20a – 20c can be used to control the device, light source, etc., which is associated with control button 20d. Such controls can be for dimming or brightening a light source, turning on or off a light source, raising or lowering a shade or blind, increasing or decreasing the volume of an audio source, etc.

Alternatively, if a user wishes to control the device, light source, etc. associated with button 20e, they would simply press button 20e, which would in turn cause the illumination to switch portions and illuminate the portion adjacent button 20e, thereby indicating that control buttons 20a – 20c are enabled for the device, light associated with control button 20e.

Similarly, FIG. 1B depicts a four-channel keypad controller 1’, having a wall plate 70 and face plate 80. The four-channel keypad 1’ likewise includes control buttons 21c – 21c, but in contrast to the two-channel controller 1 of FIG. 1A, includes four control buttons 21d – 21g, which are used in the same manner as the two-channel keypad controller 1. In FIG. 1B, control button 21e is actuated, as indicated by the illuminated light pipe 100 portion, which is adjacent button 21e.

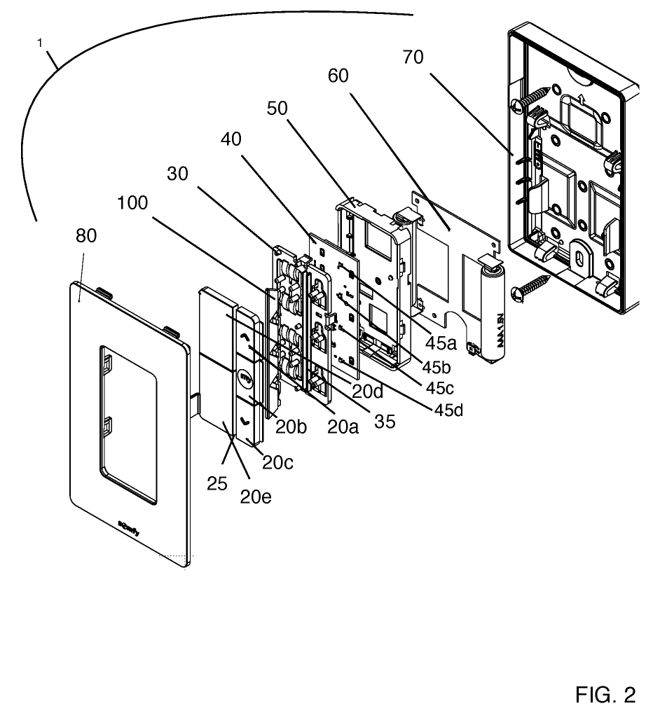

FIG. 2 depicts the two-channel keypad 1 of FIG. 1A in an exploded configuration. The keypad shown is a surface mounted keypad with wall plate 70, which also serves as a main housing. Cover plate 80 is secured to the wall plate 70, in an assembled state, to complete the main housing. The keypad can also be configured as an in-wall or flush-mount device.

Adjacent the wall plate 70, is a battery mount 60, for one or more batteries which power the keypad 1. It should be understood that the keypad can alternatively be powered by an external source. An inner housing 50, is arranged adjacent the battery mount 60 and houses the printed circuit board assembly (PCBA) 40 and light sources 45a – 45d arranged thereon. The PCBA 40, can be configured to include radios transceiver to communicate wirelessly, e.g. via WI-FI, RFID, Bluetooth®, Zigbee, or via proprietary protocols, with the devices, light sources, etc. that are being controlled.

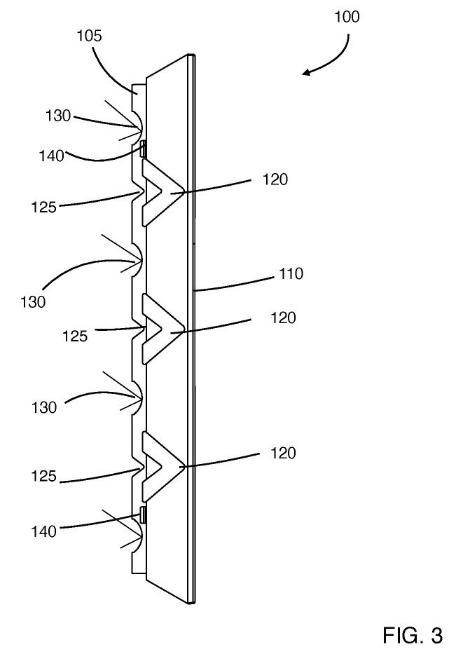

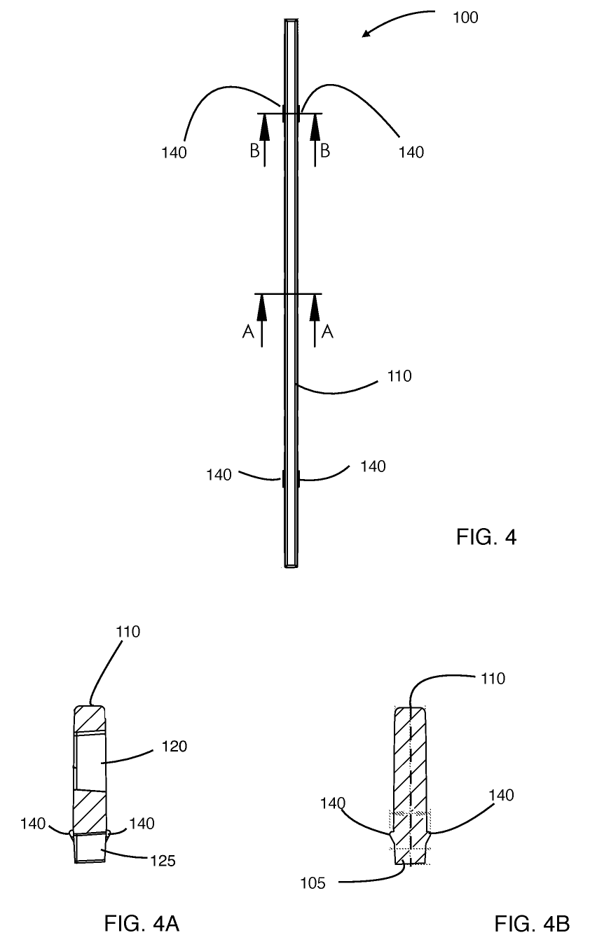

Control buttons 20a – 20e are arranged on a carrier plate 30, which includes a channel 35, configured to receive light pipe 100. The light pipe 100 includes a rear face 105 (see FIGS. 3, 4A, 4B) receivable in the channel 35. Channel 35 is configured as two side by side rails, and is configured such that the light sources 45a – 45d are aligned in between the two rails. The carrier plate 30 is open in the channel 35 between the two rails in order to permit light to pass from the light sources 45a – 45d to the light pipe 100. Further, the channel 35, includes one or more securing portions configured to secure the rear face 105 of the light pipe 100 in place therein, thereby assuring proper alignment of the light sources 45a – 45d with the light pipe 100.

Light pipe 100 has a longitudinal extension and is made of a polycarbonate material, e.g. Lexan®, and is partially textured to improve diffusion and appearance. As shown in FIG. 3, the light pipe 100 has rear face 105, discussed above, which includes light guides 130, that are curved cutouts in the rear face 105. The light pipe 100 further includes a front face 110, opposite the rear face 105. Light barriers 120 are disposed along a length in a main body portion of the light pipe 100 and serve to delineate sections of the light pipe 100 without a visible seam. Owing to the position of the light barriers, the same light pipe can be used in keypad controllers having different numbers of channels. Light pipe 100 has a generally flat shape, its width across the longitudinal extension being much smaller than its length along the longitudinal extension. Its width is also smaller than its depth, from rear face 105 to front face 110.

The light barriers 120 have a hollow generally triangular shape and prevent light from bleeding into an adjacent channel due to the absence of material which would transmit light. Preferably, the light barriers 120 are made integrally with the light pipe 100. In particular, they are made as cutouts from the light pipe 100, as shown in FIG. 4A, thereby making the light barriers 120 triangular voids within the light pipe 100.

The rear face 105 further includes triangular notches 125 disposed between the light guides 130 and aligned with the light barriers. The triangular notches 125 effectively serve to separate two adjacent light guides 130, owing to their pointed shape.

The light pipe 100 further includes one or more fixation members 140 that are engageable with the securing portion of the channel 35 of the carrier plate 30.

As shown in FIGS. 4, 4A and 4B, the fixation members 140 protrude slightly, serving to create a friction fit with the securing portion of the channel 35 of the carrier plate 30. Section line A-A is taken through the center of the light pipe 100 through the center light barrier 120. FIG. 4A shows the empty space in the light pipe, which prevents transmission of light thereby creating a seamless division of sections.

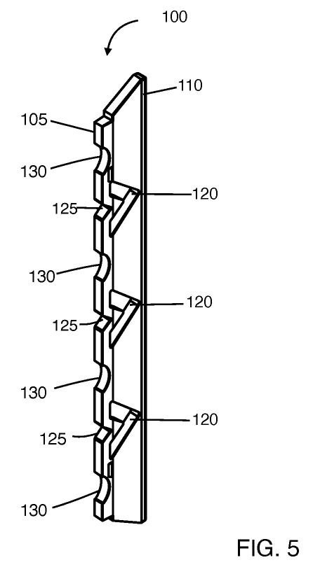

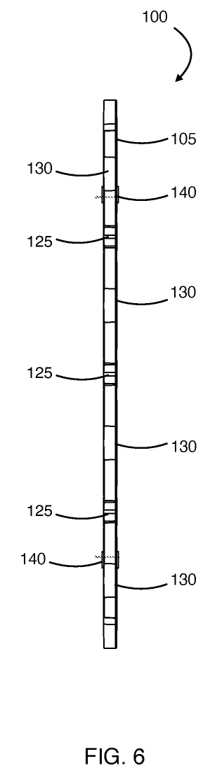

FIGS. 5-6 are different views of the light pipe 100 and are provided for better understanding of the orientation of the components.

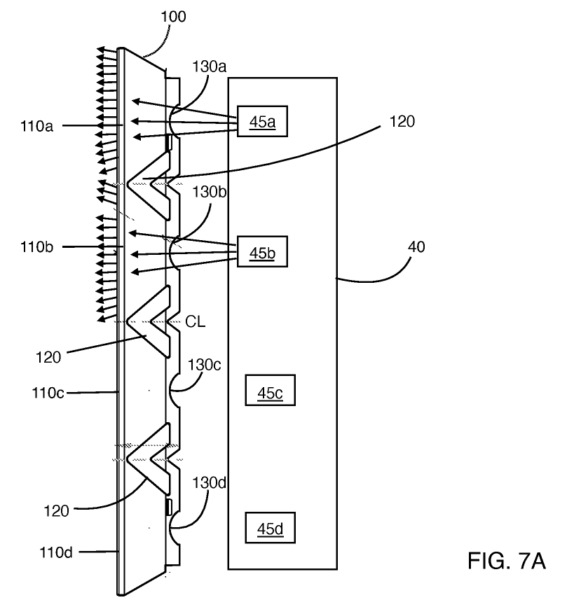

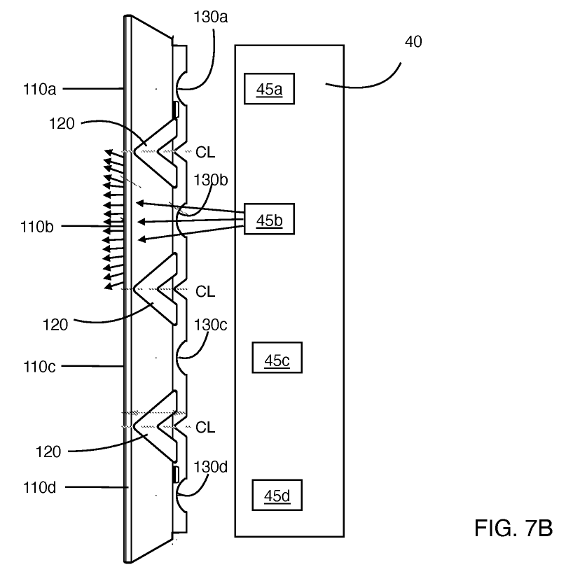

FIG. 7A is a schematic representation of the light pipe 100 being illuminated. In the example of FIG. 7A, a two-channel keypad is depicted in which light sources 45a and 45b are actuated, illuminating a top portion 110a of the front face of the light pipe 100. Lower portion 110b is not illuminated since the light barrier 120 in the middle of the light pipe 100 does not permit the light from light source 45b to extend generally beyond a center line CL of the front face 110 of the light pipe 100. Referring back to FIG. 1A, the illumination of the light pipe 100 at front face portion 110a corresponds to illuminating control button 20d.

In the two-channel example of FIG. 7A, both light sources 45a and 45b are actuated, directing light to light guides 130a and 130b, in order to illuminate portions 110a and 110b of the front face 110 of the light pipe 100, which collectively correspond to the section of the light pipe 100 adjacent to control button 20d, thereby indicating that control buttons 20a – 20c are active for controlling the device, light source, etc. associated with control button 20d.

Similarly, FIG. 7B is a schematic representation of the light pipe 100 being illuminated. In the example of FIG. 9B, a four-channel keypad is depicted in which light source 45b is actuated, illuminating only portion 110b of the front face of the light pipe 100. Remaining portions 110a, 110c and 110d are not illuminated since the light barriers 120 that flank light guide 130b prevent the light from light source 45b to extend generally beyond a center line CL of the of each of the light barriers 120. Referring back to FIG. 1B, the illumination of the light pipe 100 at front face portion 110b corresponds to illuminating control button 20e.

It should be noted that, owing to its design, the same light pipe 100 and PCBA 40 (including light sources 45a – 45d) can be used in both the two-channel as well as the four-channel keypad controllers 1, 1’, which reduces the number of different parts required and associated costs.

If the light pipe 100 is to be used in a three-channel keypad, the light pipe can be modified to include only two barriers 120 instead of three.

The light sources 45a-45d can be LEDs that are tuned to provide different color indications for the control buttons 20d - 20e, 21d – 21g. For example, portions 110a and 110b of the front face 110 of the light pipe 100 can be illuminated with a green color, indicating that control button 20d is active, and portions 110c and 110d of the front face 110 of the light pipe 100 can be illuminated with a red color, indicating that it is inactive.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A keypad controller comprising:
a housing portion, which houses therein:
a printed circuit board assembly (PCBA) comprising a plurality of light sources arranged in a single line thereon;
a carrier plate arranged adjacent the PCBA, the carrier plate comprising a through opening, aligned with the light sources;
a light pipe arranged adjacent the through opening;
a plurality of control buttons arranged on the carrier plate on either side of the light pipe; and
a faceplate comprising an opening corresponding to the arrangement of the control buttons and light pipe on the carrier plate, permitting access thereto, the faceplate securable to the housing portion.

2. The keypad controller of claim 1, wherein the keypad controller is configured as a multi-channel controller for controlling multiple devices utilizing the same control buttons.

3. The keypad controller of claim 1, wherein the keypad controller is configured to control at least one of: a motorized shade, a motorized blind, motorized curtains, a motorized awning, motorized screens, motorized slats, a lighting source, an audio source, a fan, a thermostat or a security system.

4. The keypad controller of claim 1, wherein the light pipe comprises a rear face and a front face opposite thereto, the rear face receivable in the through opening of the carrier plate, the front face being generally planar with the control buttons in an assembled state.

5. The keypad controller of claim 4, wherein the rear face comprises a plurality of light guides arranged in alignment with the light sources.

6. The keypad controller of claim 5, wherein the light pipe comprises at a plurality of light barriers disposed between the front face and the rear face spaced along a length of the light pipe.

7. The keypad controller of claim 6, wherein the light barriers are comprised of generally triangular shaped voids.

8. The keypad controller of claim 6, wherein the rear face comprises triangular notches disposed in between two adjacent light guides and in line with the light barriers.

9. The keypad controller of claim 6, wherein the light barriers delineate illuminable portions of the front face.

10. The keypad controller of claim 9, wherein an illuminated portion of the front face corresponds to an active control button of the keypad controller.

11. A light pipe for use in an electronic control device, the light pipe having a longitudinal extension and comprises a rear face and a front face opposite thereto.

12. The light pipe of claim 11, wherein the rear face comprises a plurality of light guides arranged to be aligned with a plurality of light sources in order to guide light emitted from said plurality of light sources towards said front face.

13. The light pipe of claim 12, wherein the light pipe comprises a plurality of light barriers disposed between the front face and the rear face spaced along a length of the light pipe.

14. The light pipe of claim 13, wherein the light barriers are comprised of generally triangular shaped voids.

15. The light pipe of claim 14, wherein the rear face comprises triangular notches disposed in between two adjacent light guides and in line with the light barriers.

16. The light pipe of claim 13, wherein the light barriers delineate illuminable portions of the front face.

17. The light pipe of claim 11, wherein the light pipe is used in a multi-channel keypad controller.

18. The light pipe of claim 17, wherein a portion of the front face of the light pipe is illuminated to indicate an active channel controllable by a control buttons of the multi-channel keypad controller.

19. The light pipe of claim 17, wherein the multi-channel keypad controller is configured to control at least one of: a motorized shade, a motorized blind, motorized curtains, a motorized awning, motorized screens, motorized slats, a lighting source, an audio source, a fan, or a security system.

20. The light pipe of claim 17, wherein the same light pipe can be used for multi-channel keypads having different numbers of channels.
